(19) United States
(12) Patent Application Publication
(10) Pub. No.: US 2026/0188948 A1
(43) Pub. Date: Jul. 2, 2026

(54) ATTACHMENT DEVICE

(71) Applicant: Tymphany HK Limited, Hong Kong (HK)

(72) Inventors: Wen Yuan, Taipei City (TW); Chang Shu, Taipei City (TW)

(21) Appl. No.: 19/371,111

(22) Filed: Oct. 28, 2025

Related U.S. Application Data
(60) Provisional application No. 63/738,939, filed on Dec. 26, 2024.

(51) Int. Cl. H01R 13/631

(52) U.S. Cl. CPC H01R 13/631; H01R 2201/26

(57) ABSTRACT

A device for connecting a connector to an electronic device includes a housing including a recess for receiving the electronic device; an arm for holding the connector and configured to rotate between a first configuration and a second configuration; a trigger element configured to move from a first position to a second position; a locking element rotatably connected to the arm; and a torsion spring connected between the locking element and the arm. Movement of the trigger element causes the trigger element to move the locking element and thereby apply a load to the torsion spring and rotate the arm. Movement of the trigger element causes the trigger element to slide over a protruding portion. The torsion spring is configured to then return to its rest position so that the protruding portion is positioned to hold the trigger element in the second position.

### CROSS REFERENCE TO RELATED APPLICATIONS

This application claims priority of U.S. Provisional Application No. 63/738,939 filed on Dec. 26, 2024 under 35 U.S.C. § 119(e), the entire contents of which are hereby incorporated by reference.

### BACKGROUND OF THE INVENTION

### Field of the Invention

The present invention relates to a device for connecting a connector to an electronic device, and to a system.

### Description of the Related Art

As electronic devices become more ubiquitous in everyday life, the connections to and from electronic devices become more important. A simple connection to an electronic device involves a connector being connected (plugged in) to the electronic device manually. This requires effort on the part of the user to locate the connector and plug its end into the electronic device. Another kind of connection scheme is magnetic or wireless connection, in which an electronic device may be charged wirelessly. Magnetic or wireless charging requires the connector and the electronic device to have the required magnetic charging components.

In light of the above, an improved connection scheme for connecting a connector to an electronic device is desired.

### SUMMARY OF THE INVENTION

According to an embodiment of a first aspect there is disclosed herein a device for connecting a connector to an electronic device, the device comprising: a housing comprising a recess for receiving the electronic device; an arm for holding at its first end the connector, wherein the arm is rotatably attached to the housing and configured to rotate between a first configuration and a second configuration, wherein rotation from the first configuration to the second configuration causes the first end of the arm to move towards an opening in the recess; a trigger element (movably attached to the housing and) which in a first position comprises at least a portion extending into the recess, the trigger element configured to move, upon force applied to the portion extending into the recess, from the first position to a second position; a locking element rotatably connected to the arm; and a torsion spring connected between the locking element and the arm, wherein movement of the trigger element from the first position to the second position causes the trigger element to push a protruding portion of the locking element protruding towards the trigger element to move the locking element and thereby apply a load to the torsion spring and, when the trigger element contacts the second end of the arm, push the second end of the arm and thereby rotate the arm from the first configuration to the second configuration, wherein the movement of the trigger element causes an end of the trigger element, contacting the protruding portion (and the second end of the arm), to slide over the protruding portion, wherein the torsion spring is configured to then return to its rest position, thereby moving the locking element so that the protruding portion is positioned to hold the trigger element in the second position.

The movement of the first end of the arm towards the opening in the recess may cause the connector to protrude through the opening.

The movement of the first end of the arm towards the opening in the recess may be for causing the connector to connect to the electronic device when the electronic device is in the recess.

The arm may comprise means for mounting the connector at the first end of the arm, and the means for mounting the connector may enable the position of the connector to be adjusted (when it protrudes though the opening and into the recess).

The device may comprise at least one first resilient member connected between the housing and the arm and configured to bias the arm towards the first configuration.

The device may comprise at least one second resilient member connected between the housing and the trigger element and configured to bias the trigger element towards the first position.

The at least one first resilient member may comprise at least one first spring.

The at least one second resilient member may comprise at least one second spring.

The arm may have substantially an L-shape.

In the torsion spring's rest position the protruding portion of the locking element may protrude beyond the arm.

In the second position, the portion of the trigger element extending into the recess in the first position may extend into the recess less than in the first position or may not extend into the recess.

The trigger element may be configured to move from the first position to the second position upon receipt of the electronic device into the recess.

When the trigger element is in the first position, (in the torsion spring's rest position) the protruding portion of the locking element may protrude beyond the arm towards the trigger element.

The torsion spring may comprise a first spring arm and a second spring arm, the first spring arm connected to the locking element and the second spring arm connected to the arm.

The locking element may comprise a locking element groove or a locking element extension and the first spring arm may abut an edge of the locking element groove or locking element extension.

The arm may comprise an arm groove or an arm extension and the second spring arm may abut an edge of the arm groove or arm extension.

The rotation of the arm from the first configuration to the second configuration may cause (due to the locking element being connected to the arm) movement of the locking element which has a component in a direction perpendicular to the movement of the trigger element from the first position to the second position and thereby enable the end of the trigger element to slide over the protruding portion (of the locking element).

The locking element may be rotatably attached to the arm and the arm rotatably attached to the housing at a common attachment point.

The locking element may be rotatably attached to the arm at a location on the arm which is on a side of an attachment point where the arm is rotatably attached to the housing towards the second end of the arm.

The device may comprise a frame surrounding the opening and movable with respect to the housing.

The device may comprise at least one slider structure to enable the movement of the frame with respect to the housing.

An opening defined by the frame may be narrower than the opening in the recess.

The connector may be for charging and/or communication with the electronic device.

The connector may be for transmitting power and/or an audio signal to the electronic device

The device may be for use in a vehicle to connect the electronic device to the vehicle.

According to an embodiment of a second aspect there is disclosed herein a system comprising the device according to the first aspect and the connector, wherein the connector is attached to the first end of the arm.

The system may comprise the electronic device.

When the arm is in the second configuration and the electronic device is inside the recess the connector may protrude through the opening and be connected to the electronic device.

Receipt of the device in the recess may impart force upon the portion of the trigger element extending into the recess in the first position and cause the movement of the trigger element from the first position to the second position.

The connector may be for charging and or communication with the electronic device.

The electronic device may comprise a speaker and the connector may be for connecting the device to the vehicle to transmit power and/or an audio signal from the vehicle to the electronic device.

Features relating to any aspect/embodiment may be applied to any other aspect/embodiment.

### BRIEF DESCRIPTION OF THE DRAWINGS

Reference will now be made, by way of example, to the accompanying drawings, in which:

FIG. 1 is a diagram illustrating a device;

FIG. 2 is a diagram illustrating the device;

FIGS. 3a-3c are diagrams illustrating movement of the device; and

FIG. 4 is a diagram illustrating a frame.

### DETAILED DESCRIPTION

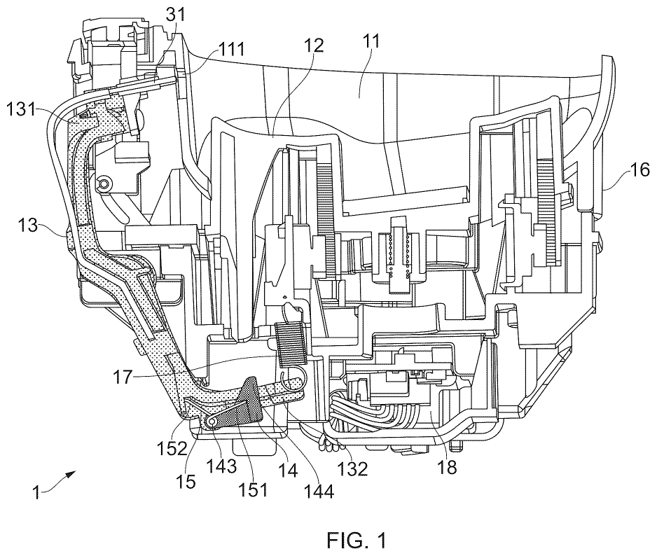

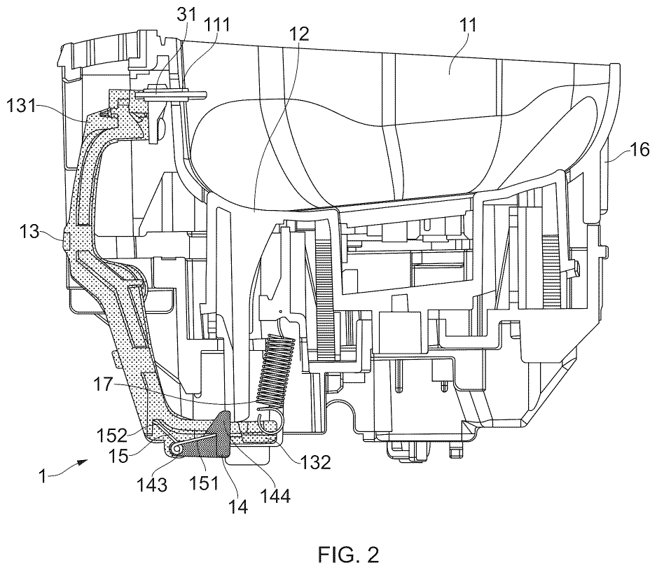

FIGS. 1 and 2 are diagrams illustrating a device 1 which may be referred to as an attachment device 1. The device 1 is a particular implementation of a device for connecting a connector to an electronic device, of the present invention. FIGS. 1 and 2 each show a cross section of the device 1. FIG. 2 shows a different slice of the device 1 compared to FIG. 1 (i.e., a cross section at a different depth through the device 1) to better illustrate the interaction between the trigger element 12 and the locking element 14.

The device 1 comprises a housing 16, an arm 13, a trigger element 12, a torsion spring 15, a spring 17, and a connection part 18 (to clearly show the other elements the connection part is not illustrated in FIG. 2). The housing 16 comprises a recess 11 for receiving the electronic device.

The arm 13 comprises a first end 131 and a second end 132. The first end 131 is for holding a connector 31 to be connected to the electronic device. For instance, the first end 131 comprises means for holding the connector 31. The arm is rotatably attached to the housing 16 and configured to rotate between a first configuration as shown in FIG. 1 and a second configuration as shown in FIG. 2. In the second configuration the first end 131 is closer to an opening 111 in the recess 11. As shown in FIG. 2, in the second configuration, the connector 31 extends through the opening 111 and into the recess 11.

The trigger element 12 is movably attached to the housing 16 and configured to move between a first position as shown in FIG. 1 and a second position as shown in FIG. 2. In the first position, the trigger element 12 extends into the recess 11. That is, in the first position, the trigger element 12 comprises at least a portion extending into the recess 11. In this implementation, the trigger element 12 does not extend into the recess 11 at all in the second position, however this is not essential and in other implementations the trigger element 12 may still extend into the recess 11 in the second position, but will extend less into the recess 11. That is, in other implementations, in the second position a smaller portion of the trigger element 12 extends into the recess 11 compared to the first position.

When the trigger element 12 is moved from the first position to the second position, this movement causes the arm 13 to rotate from the first configuration to the second configuration and thereby causes the connector 31 to extend through the opening 111 into the recess 11 (and into the electronic device if present in the recess, specifically into a connection port of the electronic device). That is, the trigger element 12 pushes the second end 132 of the arm 13 to rotate the arm 13.

The locking element 14 is rotatably connected to the arm 13. The torsion spring 15 is connected between the locking element 14 and the arm 13. As already noted above, in FIG. 1, the arm 13 is in the first configuration and the trigger element 12 is in the first position. In this configuration no external force is being applied to the trigger element, and the torsion spring 15 is in its rest position (here, rest position is used relatively to distinguish from a loaded position described later, but there may be some tension in the torsion spring 15 in this so-called rest position). When the torsion spring 15 is in its rest position as shown in FIG. 1, a protruding portion 144 of the locking element 14 protrudes beyond the arm 13. The torsion spring 15 comprises first and second spring arms 151, 152. The first spring arm 151 is attached to (or wedged inside a groove of) the locking element 14 and the second spring arm is attached to (or wedged inside a groove of) the arm 13.

When the trigger element 12 is in the second position, as shown in FIG. 2, the locking element 14, which is rotated during the movement of the trigger element 12 from the first position to the second position, has rotated back to its initial position with respect to the arm 13 due to the rotation of the torsion spring 15 back to its rest position. The protruding portion 144 thereby extends beyond the arm 13 when the trigger element 12 is in the second position and prevents the trigger element 12 from returning to the first position. The arm 13 is thereby locked into its second configuration in which the connector 31 extends through the opening 111 into the recess 11.

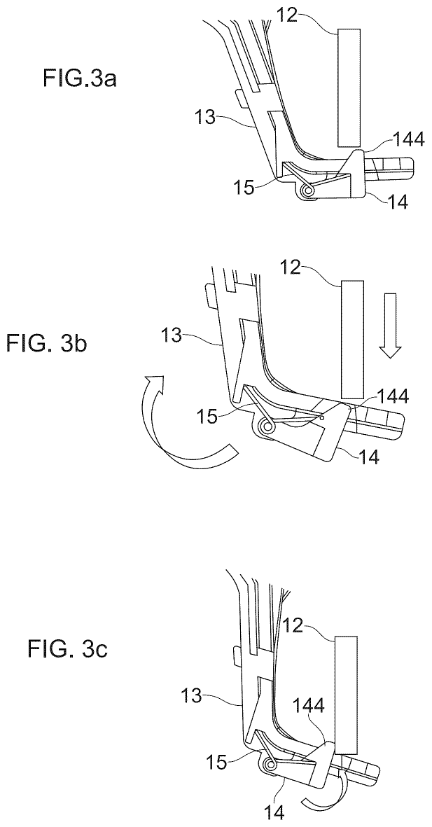

FIGS. 3a-3c are diagrams illustrating the movement of the trigger element 12 from the first position to the second position and the corresponding movement of the arm 13 from the first configuration to the second configuration. Only a portion of the device 1 is illustrated, for convenience. Thye trigger element 12 is illustrated as a simple rectangular shape for convenience. Of course, the trigger element 12 is not limited to the shape shown in FIGS. 1 and 2 or the shape shown in FIGS. 3a-3c and may take any suitable shape.

In FIG. 3a, the trigger element 12 is in the first position and the arm 13 is in the first configuration.

In FIG. 3b, a force is applied to the trigger element 12 in the direction indicated by the straight arrow. The force causes movement of the trigger element 12 towards the second end 132 of the arm 13. The trigger element 12 first contacts the protruding portion 144 of the locking element 14 and thereby moves the locking element 14 and applies a load to the torsion spring 15. When the trigger element 12 contacts the second end 132 of the arm 13, it pushes the second end 132 of the arm 13 to rotate the arm 13 from the fist configuration towards the second configuration as illustrated by the curved arrow. As the trigger element 12 continues to move in the direction indicated by the straight arrow, the arm 13 continues to rotate and the thus the locking element 14 is moved away from the trigger element 12 due to the rotation of the arm 13.

At one point, the end of the trigger element 12 contacting the protruding portion 144 and the second end 132 of the arm 13 slides over the protruding portion 144. After the end of the trigger element 12 slides over the protruding portion 144, there is nothing to prevent the locking element 14 rotating back to its initial position with respect to the arm 13 under the action of the torsion spring 15 and thus the torsion spring 15 returns to its rest position thereby rotation the locking element 14. The rotation of the locking element 14 is indicated by the curved arrow in FIG. 3c. The rotation of the arm 13 from the first configuration to the second configuration causes movement of the locking element 14 which has a component in a direction (to the left-hand-side in FIGS. 3a-3c) perpendicular to the movement of the trigger element 12 from the first position to the second position and thereby enables the end of the trigger element 12 to slide over the protruding portion 144.

FIG. 3c, the device 1 is shown when the trigger element 12 is in the second position, the arm 13 is in the second configuration, and the locking element 14 is in its original position with respect to the arm 13 (and the torsion spring 15 is in its rest position). That is, FIG. 3c shows the device 1 when the end of the trigger element 12 has slid over the protruding portion 144 and thus the torsion spring 15 has returned to its rest position thereby rotating the locking element 14 so that the protruding portion 144 extends/protrudes beyond the arm 13. In this configuration the protruding portion 144 blocks the trigger element 12 from returning to the first position (and, indeed, from moving towards the first position) and thus the locking element 14 locks the arm 13 in the second configuration in which the connector 31 extends through the opening 111 into the recess 11. The locking element 14 (or more specifically the protruding portion 144) may be considered to resist the trigger element 12 returning to the first position or to impede movement of the trigger element 12 from the second position (to the first position). It may be considered that the locking element 14 together with the torsion spring 15 blocks the trigger element 12.

In use of the device 1, the electronic device is inserted into the recess 11 which pushes the trigger element 12 from the first to the second position, which thereby rotates the arm 13 from the first to the second configuration, thereby causing the connector 31 to extend through the opening 111 and into the electronic device which is now located in the recess 11. The electronic device is inserted into the recess 11 in such a configuration so that a connection port for receiving the connector 31 is lined up with the opening 111. The device 1 thereby provides a convenient connection scheme in which a user simply inserts the electronic device into the recess 11 to connect the connector 31 to the electronic device. The device 1 then locks in the connected configuration to provide stability in the connection. When the device 1 is in an unconnected configuration (in which the arm 13 is in the first configuration), the connector 31 does not extend through the opening 111 into the recess 11 and thus the connector 31 is protected compared to a conventional connection scheme in which a connector is simply picked up and inserted into an electronic device. This may prevent physical damage to the connector 31 and may prevent dirt and dust getting on or inside the connector 31 and causing damage.

In the implementation of the device 1 shown in FIGS. 1-3c, the locking element 14 is rotatably attached to the arm 13 at an attachment point 143. The attachment point 143 coincides with the center-ring of the torsion spring 15, which is also attached to the arm 13 and the locking element 14 at the attachment point 143. The attachment point 143 may also be where the arm 13 is rotatably attached to the housing 16. This arrangement is not essential. That is, the locking element 14 may be rotatably attached to the arm 13 at a point different from the point at which the arm 13 is attached to the housing 16 (the locking element 14 may be rotatably attached to the arm 13 at a location on the arm 13 which is on a side of an attachment point where the arm 13 is rotatably attached to the housing 16 towards the second end 132 of the arm 13). In other implementations, the locking element 14 may be rotatably connected to the arm 13 by virtue only of the torsion spring 15. That is, the locking element 14 may be rotatably connected to the arm 13 by virtue only of its attachment to the first spring arm 151 of the torsion spring 15.

In the implementation of the device 1 in FIGS. 1-3c, a spring 17 (or more generally a resilient member) is connected between the second end 132 of the arm 13 and the housing 16 and is put under load when the arm 13 is rotated to the second configuration, to thereby provide a force biasing the arm 13 towards the first configuration. A resilient member (e.g., spring) may be connected between the housing 16 and the first end 131 of the arm 13 instead of or as well as the spring 17. The device 1 may comprise a second spring (or resilient member) connected between the trigger element 12 and the housing 16 to bias the trigger element 12 towards the first position. In a particular implementation, the force required to move the locking element 14 in a direction (anticlockwise in FIGS. 3a-3c) so that the trigger element 12 can return to the first position is greater than the restoring force provided by the spring 17 and the spring connected between the trigger element 12 and the housing 16.

The device 1 may comprise a mechanism for unlocking the device 1 when it is in the connected configuration. For example, the device 1 may comprise a button connected to a pin that when pressed causes the pin to push the locking element 14 is a direction so as to release the trigger element 12 and allow the trigger element 12 to return to the first position (e.g., under the restoring force of a spring connected between the trigger element 12 and the housing 16, and/or e.g. under the restoring force of a spring connected between the arm 13 and the housing 16) and thus the arm 13 to return to the first configuration. In such an implementation, the pin pushes the locking element 14 in a direction so that the torsion spring 15 twists in a direction opposite to that in which it twists when the trigger element 12 is moved from the first position to the second position. As another example, the trigger element 12 may comprise a projection which may be pulled or pushed to pull or push the trigger element 12 from the second position to the first position. In the case that the device 1 comprises a spring to bias the trigger element 12 towards the first position, once the trigger element 12 is moved partially towards the first position, the locking element 14 will no longer be blocking the trigger element 12 and the trigger element 12 will thus move back to the first position due to the restoring force of the spring.

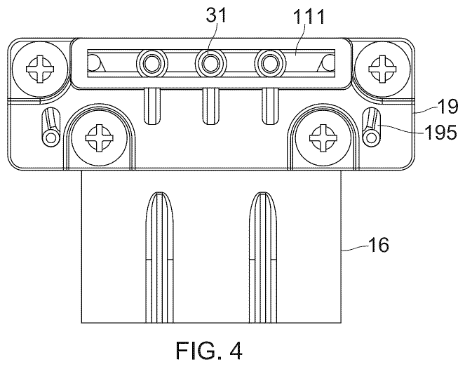

The device 1 may comprise a frame 19 which is movably attached to the housing 16 and located to surround the opening 111. FIG. 4 is a diagram illustrating the frame 19. When the arm 13 is in the second configuration, the connector 31 extends through the frame 19 (and thus through the opening 111). The frame 19 is movable so that the position at which the connector 31 extends out of the opening 111 may be adjusted, e.g., to suit the particular electronic device being used. In the implementation shown in FIG. 4, the frame 19 is movable with respect to the housing 16 in a vertical direction. The connector 31 is movable inside the frame in a horizontal direction, e.g., to suit the particular electronic device being used. That is, the movement of the frame 19 and the movement of the connector 31 provides for adjustment of the position of the connector when it extends through the opening 111 (and the frame 19) so that correct connection to the electronic device may be ensured.

The device 1 comprises means for movement of the frame 19 with respect to the housing 16. In the FIG. 4 implementation, this comes in the form of a slider structure 195 whereby the frame comprises two slider openings and the housing comprises two corresponding slider knobs which extend into the slider openings and are slidable/movable within the slider openings. There may be more than two slider structures.

In use of the device 1, the trigger element 12 may be pushed by a user to cause the connector 31 to extend through the opening 111 and into the recess 11 so that the position of the connector 31 may be adjusted. It can thus be ensured that when the electronic device is inserted into the recess 11, the connector 31 is in the correct position to connect to the electronic device. The connector 31 may comprise a plurality of connectors, and the spacing between these connectors may be adjusted. The connector 31 (and the individual connectors) may be referred to as telescopic probes.

As shown in FIG. 1, the device 1 comprises a connection part 18. The connection part 18 is electrically connected to the connector 31 and provides power and/or communication to and/or from the electronic device to be connected to the connector 31 via the connector 31. The connection part 18 is for connection to another electronic device or system or component. For instance, the connection part 18 may be connected to a power source and thereby the connection of the connector 31 to the electronic device provides power to the electronic device. The electronic device for connection to the connector 31 may be, for example, a mobile device, user equipment, personal user device, (portable) speaker, or a power bank, among other electronic devices. The device 1 may provide for connection to the electronic device to provide power and/or communication to and/or from the electronic device.

In a particular implementation, the device 1 may be installed and/or used in a vehicle. The device 1 may be considered particularly advantageous in a vehicle because the motion of the vehicle may cause a traditional connector to physically disconnect from an electronic device (or at least cause intermittent connection), whereas the connection provided by the device 1 is more stable and resistant to motion/bouncing of the vehicle.

For example, the connection part 18 may be connected to a power source and/or audio system and/or vehicle computer of the vehicle. In an implementation in which the electronic device is a (portable) speaker, the connector 31 may comprise a connector for transferring power to the speaker and/or a connector (may be the same connector) for transmitting an audio signal to cause the speaker to output audio. The power may come from the vehicle (battery) and the audio signal may come from the vehicle audio system and/or computer. In an implementation in which the electronic device is a power bank, the connector 31 may comprise a terminal for transferring power to the power bank which may come from the vehicle (battery). In an implementation in which the electronic device is a mobile device or user equipment or personal user device, the connector(s) 31 may transfer power to and/or communicate (e.g. audio and/or video signals) with the electronic device based on power and/or signals from the vehicle (battery) and/or audio system/computer.

In the device 1, the arm 13 is of a generally L-shape. This shape is not essential. In other implementations, the arm 13 may be substantially straight or may be curved and/or bent in a number of different ways. The arm 13 is rotatably attached to the housing 16, e.g. at the attachment point 143, or may be rotatably attached at a different location. In the device 1, the locking element 14 is of a generally triangular shape. This shape is not essential, and in other implementations, the locking element 14 may have a different shape, provided it has a protruding portion 144 for interacting with the trigger element 12 as described above.

In the device 1, the recess 11 is preferably sized and shaped according to the electronic device for connection via the connector 31, although the fit need not be tight, and in this way, a number of different electronic devices with possibly different sizes may be used with the device 1. As already described above, the connector position may be adjusted by applying force to the trigger element 12 to cause the connector 31 to extend into the recess 11.

As described above, a particular implementation of the device 1 has been described and many variations exist. For instance, the movement of the trigger element 12 from the first to the second position need not be vertical and could be e.g., horizontal or another direction. The vertical movement may have an advantage in that the electronic device may be more easily and securely inserted into the recess 11.

In a particular implementation in which the movement of the trigger element 12 from the first to the second position is vertically down (substantially) and is provided by a pressing force of the electronic device being depressed into the recess 11, the strength of the torsion spring 15 and of the spring 17 and the spring connecting the trigger element 12 to the housing 16 is such that, when the electronic device is in the recess 11 and thus the trigger element 12 is in the second position, the force provided by the spring 17 and the other spring is not sufficient to counteract the weight of the electronic device and the resistive force of the torsion spring 15 and so the trigger element 12 remains in the second position and the arm 13 remains in the second configuration. However, when the electronic device is removed from the recess 11, the force provided by the spring 17 and the other spring is sufficient to overcome the resistive force of the torsion spring 15 so that the trigger element 12 moves up to the first position, rotating the locking element 14 out of its way and overcoming the resistive force of the torsion spring 15 in the process. In this way, removal of the electronic device causes the connector to retreat back through the opening 111. To achieve the advantage of improved stability in this particular implementation, e.g., in a vehicle, the magnitude of the force on the trigger element 12 due to the spring 17 and the other spring may be only slightly higher than the resistive force of the torsion spring 15—so that, when the electronic device moves upwards slightly, e.g., due to a bump causing the vehicle to rise/bounce, the device 1 does not unlock itself and the arm 13 remains in the second configuration with the connector 31 extended and connected with the electronic device. In this implementation, the device 1 may not comprise any mechanism for unlocking the device when it is in the connected configuration described above.

In general, the connector 31 may be or comprise any suitable connector type. For example, the connector 31 may comprise any power and/or data connector. The connector 31 may for example comprise any of the following connectors: any USB connector, any power connector, an auxiliary (aux) connection, an HDMI connection, among other connectors and connection types.

In the device 1, the opening 111 is located according to the electronic device being connected to, and may be at a different location to that shown in FIGS. 1 and 2. The shape of the trigger element 12 in the device 1 shown in FIGS. 1 and 2 is not essential and the trigger element 12 may have many other shapes, provided the end of the trigger element 12 interacts with the locking element 14 (particularly its protruding portion 144) and the second end 132 of the arm 13 substantially as described above.

As already described above, existing connection schemes include a simple manual connection whereby a user plugs a connector into an electronic device, and a magnetic/wireless connection scheme. Problems or shortcomings encountered in the existing connection schemes include:
in the manual connection scheme, the connector is exposed when not in use. This is aesthetically not pleasing. Furthermore, ingress of dirt or dust may occur due to the exposure of the connector.
the magnetic/wireless scheme requires the design of the magnetic structure at the receiving and sending ends, which has limitations and requirements for the design of communication products, and the versatility is not high.

The device 1 according to the present disclosure has the following advantages:
The electronic device is automatically connected with the connector 1 when it is placed in place (in the recess 11) for communication and/or charging, and the device 1 locks itself so the connector 31 stays in place.
In the particular implementation in which the force provided by the spring 17 and the other spring connecting the trigger element 12 and the housing 16 overcomes the resistive force of the torsion spring 15, when the electronic device is removed, the connector 31 is automatically disconnected, and the charging or communication function stops.
The position of and/or separation between probes of the connector 31 may be adjusted to increase the versatility.

Also disclosed herein is a system comprising the device 1 described above, the connector 31, and optionally the electronic device. The system may also comprise another electronic device (which is connected to the electronic device when the connector 31 is inserted into the electronic device), or the vehicle.

The above-described embodiments of the present invention may advantageously be used independently of any other of the embodiments or in any feasible combination with one or more others of the embodiments.

The disclosure extends to the following statements.

S1. A device for connecting a connector to an electronic device, the device comprising:
a housing comprising a recess for receiving the electronic device;
an arm having a first end and a second end for holding at the first end the connector, wherein the arm is rotatably attached to the housing and configured to rotate between a first configuration and a second configuration, wherein rotation from the first configuration to the second configuration causes the first end of the arm to move towards an opening in the recess;
a trigger element which in a first position comprises at least a portion extending into the recess, the trigger element configured to move, upon force applied to the portion extending into the recess, from the first position to a second position;
a locking element rotatably connected to the arm; and
a torsion spring connected between the locking element and the arm,
wherein movement of the trigger element from the first position to the second position causes the trigger element to push a protruding portion of the locking element protruding towards the trigger element to move the locking element and thereby apply a load to the torsion spring and, when the trigger element contacts the second end of the arm, push the second end of the arm and thereby rotate the arm from the first configuration to the second configuration,
wherein the movement of the trigger element causes an end of the trigger element, contacting the protruding portion, to slide over the protruding portion, wherein the torsion spring is configured to then return to its rest position, thereby moving the locking element so that the protruding portion is positioned to hold the trigger element in the second position.

S2. The device according to statement S1, wherein the movement of the first end of the arm towards the opening in the recess is for causing the connector to connect to the electronic device when the electronic device is in the recess.

S3. The device according to statement S1 or S2, comprising at least one first resilient member connected between the housing and the arm and configured to bias the arm towards the first configuration.

S4. The device according to any of statements S1 to S3, comprising at least one second resilient member connected between the housing and the trigger element and configured to bias the trigger element towards the first position.

S5. The device according to any of the preceding statements, wherein in the second position, the portion of the trigger element extending into the recess is less than that in the first position or does not extend into the recess.

S6. The device according to any of the preceding statements, wherein the trigger element is configured to move from the first position to the second position upon receipt of the electronic device into the recess.

S7. The device according to any of the preceding statements, wherein when the trigger element is in the first position, the protruding portion of the locking element protrudes beyond the arm towards the trigger element.

S8. The device according to any of the preceding statements, wherein the torsion spring comprises a first spring arm and a second spring arm, the first spring arm connected to the locking element and the second spring arm connected to the arm.

S9. The device according to any of the preceding statements, wherein the locking element is rotatably attached to the arm and the arm is rotatably attached to the housing at a common attachment point.

S10. The device according to any of statements S1 to S8, wherein the locking element is rotatably attached to the arm at a location on the arm which is on a side of an attachment point where the arm is rotatably attached to the housing towards the second end of the arm.

S11. The device according to any of the preceding statements, comprising a frame surrounding the opening and movable with respect to the housing.

S12. The device according to statement S11, comprising at least one slider structure to enable the movement of the frame with respect to the housing.

S13. The device according to any of the preceding statements, wherein the connector is for charging and/or communication with the electronic device.

S14. The device according to any of the preceding statements, wherein the connector is for transmitting power and/or an audio signal to the electronic device

S15. The device according to any of the preceding statements, wherein the device is for use in a vehicle to connect the electronic device to the vehicle.

S16. A system comprising the device according to any of the preceding statements and the connector, wherein the connector is attached to the first end of the arm.

S17. The system according to statement s16, further comprising the electronic device.

S18. The system according to statement S17, wherein when the arm is in the second configuration and the electronic device is inside the recess, the connector protrudes through the opening and is connected to the electronic device.

S19. The system according to statement S17 or S18, wherein receipt of the device in the recess imparts force upon the portion of the trigger element extending into the recess in the first position and causes the movement of the trigger element from the first position to the second position.

S20. The system according to any of statements S17 to S19, wherein the electronic device comprises a speaker and wherein the connector is for connecting the device to the vehicle to transmit power and/or an audio signal from the vehicle to the electronic device.

1. A device for connecting a connector to an electronic device, the device comprising:
a housing comprising a recess for receiving the electronic device;
an arm having a first end and a second end for holding at the first end the connector, wherein the arm is rotatably attached to the housing and configured to rotate between a first configuration and a second configuration, wherein rotation from the first configuration to the second configuration causes the first end of the arm to move towards an opening in the recess;
a trigger element which, in a first position, comprises at least a portion extending into the recess, the trigger element configured to move, upon force applied to the portion extending into the recess, from the first position to a second position;
a locking element rotatably connected to the arm; and
a torsion spring connected between the locking element and the arm,
wherein movement of the trigger element from the first position to the second position causes the trigger element to push a protruding portion of the locking element protruding towards the trigger element to move the locking element and thereby apply a load to the torsion spring and, when the trigger element contacts the second end of the arm, push the second end of the arm and thereby rotate the arm from the first configuration to the second configuration, and
wherein the movement of the trigger element causes an end of the trigger element, contacting the protruding portion, to slide over the protruding portion, wherein the torsion spring is configured to then return to its rest position, thereby moving the locking element so that the protruding portion is positioned to hold the trigger element in the second position.

2. The device as claimed in claim 1, wherein the movement of the first end of the arm towards the opening in the recess is for causing the connector to connect to the electronic device when the electronic device is in the recess.

3. The device as claimed in claim 1, further comprising at least one first resilient member connected between the housing and the arm and configured to bias the arm towards the first configuration.

4. The device as claimed in claim 1, further comprising at least one second resilient member connected between the housing and the trigger element and configured to bias the trigger element towards the first position.

5. The device as claimed in claim 1, wherein, in the second position, the portion of the trigger element extending into the recess is less than that in the first position or does not extend into the recess.

6. The device as claimed in claim 1, wherein the trigger element is configured to move from the first position to the second position upon receipt of the electronic device into the recess.

7. The device as claimed in claim 1, wherein, when the trigger element is in the first position, the protruding portion of the locking element protrudes beyond the arm towards the trigger element.

8. The device as claimed in claim 1, wherein the torsion spring comprises:
a first spring arm connected to the locking element; and
a second spring armand connected to the arm.

9. The device as claimed in claim 1, wherein the locking element is rotatably attached to the arm and the arm is rotatably attached to the housing at a common attachment point.

10. The device as claimed in claim 1, wherein the locking element is rotatably attached to the arm at a location on the arm which is on a side of an attachment point where the arm is rotatably attached to the housing towards the second end of the arm.

11. The device as claimed in claim 1, further comprising a frame surrounding the opening and movable with respect to the housing.

12. The device as claimed in claim 11, further comprising at least one slider structure to enable the movement of the frame with respect to the housing.

13. The device as claimed in claim 1, wherein the connector is for charging and/or communication with the electronic device.

14. The device as claimed in claim 1, wherein the connector is for transmitting power and/or an audio signal to the electronic device.

15. The device as claimed in claim 1, wherein the device is for use in a vehicle to connect the electronic device to the vehicle.

16. A system comprising:
the device as claimed in claim 1; and
the connector,
wherein the connector is attached to the first end of the arm.

17. The system as claimed in claim 16, further comprising the electronic device.

18. The system as claimed in claim 17, wherein, when the arm is in the second configuration and the electronic device is inside the recess, the connector protrudes through the opening and is connected to the electronic device.

19. The system as claimed in claim 17, wherein receipt of the device in the recess imparts force upon the portion of the trigger element extending into the recess in the first position and causes the movement of the trigger element from the first position to the second position.

20. The system as claimed in claim 17, wherein the electronic device comprises a speaker and wherein the connector is for connecting the device to the vehicle to transmit power and/or an audio signal from the vehicle to the electronic device.
